(19) United States
(12) Patent Application Publication
(10) Pub. No.: US 2026/0009702 A1
(43) Pub. Date: Jan. 8, 2026

(54) SAMPLING LID ASSEMBLY FOR PARTICLE MONITORING SYSTEM

(71) Applicant: MERCK PATENT GMBH, Darmstadt (DE)

(72) Inventors: Mathieu ARRAULT, MOLSHEIM (FR); David CONTASSOT, MOLSHEIM (FR); Francois OBLINGER, MOLSHEIM (FR); Philippe RIVAT, MOLSHEIM (FR)

(73) Assignee: MERCK PATENT GMBH, Darmstadt (DE)

(21) Appl. No.: 18/881,175

(22) PCT Filed: Jul. 4, 2023
(86) PCT No.: PCT/EP2023/068279

§ 371 Date: Jan. 3, 2025

(30) Foreign Application Priority Data
Jul. 6, 2022 (FR) 2206912

(51) Int. Cl. G01N 1/22

(52) U.S. Cl. CPC G01N 1/2208; G01N 1/2205; G01N 1/2273

(57) ABSTRACT

The present application relates to a sampling lid assembly for a particle monitoring system, preferably a microbiological gas (for example, air) sampler or airborne particle counter. The present application also relates to a particle monitoring system comprising such sampling lid assembly.

### TECHNICAL FIELD

The present application relates to a sampling lid assembly for a particle monitoring system, preferably a microbiological gas (for example, air) sampler or airborne particle counter. The present application also relates to a particle monitoring system comprising such sampling lid assembly.

### BACKGROUND

The monitoring of sample fluids, either of liquids or more commonly of gases like air, is frequently performed for the purpose of evaluating contaminants, for classification and monitoring purposes, in a range of cleanroom and manufacturing environments requiring low levels of particles, such as cleanroom environments for electronics manufacturing or semiconductor manufacturing or measuring instruments manufacturing and aseptic environments for manufacturing pharmaceutical and biological products, such as sterile medicinal products.

For the purpose of monitoring fluid (for example, a gas, such as air) in such a context, particle monitoring systems are known and comprise microbial or active gas (for example, air) samplers and particle counters. Microbiological or active gas (for example, air) samplers and airborne particle counters are beneficial because they allow a user to sample a quantitative amount of gas (for example, air) and to determine the risk for contamination (microbial flora) to sterile products in a surrounding environment.

An example of a microbiological gas (for example, air) sampler and method for sampling, detecting and/or characterizing particles, for example, via collection, growth, and analysis of viable biological particles such as microorganisms is disclosed in EP 0 964 240 A1. This device includes an integrated sampler and impact surface, such as the receiving surface of a growth media in a petri dish, for collecting biological particles. the collected particles are then typically incubated to grow living particles and are then analyzed by different techniques including naked eyes inspection, microscopy, fluorescence or auto-fluorescence, ATP detection or others.

A particle counter as the other type of particle monitoring device typically pumps the gas to be monitored through a measuring system. A laser beam is directed into the gas flow and particles crossing the laser beam will create signals that are detected by a photomultiplier. The output of the photomultiplier has several amplifiers with different gain stages that allow discrimination of particle number and particle sizing based on the evaluation of the signals, more specifically of the amplitudes of the signals.

The present invention pertains to particle monitoring systems where the sampling section for performing a sampling process on a sample fluid, preferably a gas, such as air, which comprises either a particle collector or a particle counter, or one where the sampling section comprises a combination of a particle collector and a particle counter. The monitoring procedure and technology of the particle monitoring systems is as such unaffected by this invention, is generally known throughout the industry, and will therefore not be described in detail.

US 2021/0214121 A1 discloses an air sampler device for a particle monitoring system. The air sampler device includes a bottom plate on which a petri dish is to be placed, and a top plate that is placed on the bottom plate to surround the petri dish and that is an example of a sampling lid assembly. A vacuum tube is attached to an air port of the bottom plate. Air is then sucked into the sampler device through holes in the top plate, so that the air strikes a test media contained in the petri dish, which is accommodated inside the air sampler device between the top plate and the bottom plate. The air exits through the air port. At the end of the testing cycle, the top plate is taken off of the bottom plate, the petri dish is removed, and the top plate is replaced. The petri dish can then be analyzed to determine the level of cleanliness of the surrounding environment.

The entire device disclosed in US 2021/0214121 A1 is made of metal so that the device can be sterilized by heat, steam, vaporized hydrogen peroxide (VHP) or ethylene oxide (ETO). Since the petri dish has a diameter of about 9 cm (3.5 Inches), the top plate has a slightly larger diameter of 11.5 cm (4.5 Inches) and is thus relatively heavy. Further, the outer surfaces of the top plate are flat and smooth and difficult to grasp by a person inside the clean room who is wearing gloves. US 2021/0214121 A1 suggests providing the top plate with a concaved sidewall along the outer circumference of the top plate to create a more positive contact between the fingers of the user and the sidewall of the top plate and to achieve an about 20% reduction of the weight of the top plate.

This solution is still relatively bulky, heavy and difficult to clean as it requires sophisticated and energy-consuming sterilization equipment like an autoclaving machine which is not available at each site. Externalizing the autoclaving process is costly and requires a considerable stock of material—sterilized and used—to maintain continuous operation.

There also exist solutions in which the entire top plate or air sampler device for a particle monitoring system is made of a plastics material and is designed for single use applications. These solutions produce a large amount of waste and are still bulky, consequently not easily stackable, and thus require large storing space for stocking the material.

Finally, the current sampling lids or top plates of air sampler devices for particle monitoring systems for environmental monitoring are not optimized for a robotic and automated application which is, however, a certain trend in the industry to reduce labour and raise safety and quality standards.

Thus, the present invention aims at providing a sampling lid assembly for a particle monitoring system, preferably a microbiological gas (for example, air) sampler or airborne particle counter, that solves at least some of the problems associated with existing solutions.

### SUMMARY

To solve the above-indicated problems the present invention provides for a sampling lid assembly for a particle monitoring system as defined by claim 1, and a particle monitoring system as defined by claim 15. Preferred embodiments of the sampling lid assembly for a particle monitoring system are defined in the dependent claims.

The present invention in particular provides for a sampling lid assembly for a particle monitoring system comprising a support frame configured to be releasably attached to a sampling section of the particle monitoring system and to define a space surrounding an impacting and collecting surface, preferably a petri dish, placed on the sampling section, and a sieve configured to be removably mounted at the support frame to close an open side of the space above the impacting and collecting surface, preferably the petri dish, the sieve provided with fluid openings arranged to direct, in operation of the particle monitoring system, a fluid towards the impacting and collecting surface, preferably the petri dish, placed on the sampling section.

The sampling lid assembly of the invention is composed of a single use sieve (preferably made of a plastics material) and a reusable support frame compatible with a respective environmental particle monitoring system to reduce the level of waste by reduction of the size of the single use part, i.e. the sieve, and by avoiding the need of cleaning and autoclaving for that single-use part, and by reducing the requirements of cleaning for the reusable support frame in that its geometrical complexity is reduced (thus allowing sufficient cleaning with less sophisticated cleaning equipment and procedures).

It also reduces the weight of the parts to be handled in that the support frame and the sieve can be handled separately, and/or it reduces the volume of stock of material for continuous operation.

In that the sieve is provided without the support frame, it can be flat overall, which reduces the volume, thus the amount of packaging, and thereby contributes to rendering environmental monitoring more sustainable.

The sampling lid assembly of the invention also provides a compatible air sampling lid solution for both manual and automated use.

Preferably, the support frame and the sieve are made from different materials.

Preferably, the support frame is made from a material capable of withstanding autoclaving for sterilisation, preferably from a metal material, preferably from stainless steel, and the sieve is made from a disposable material, preferably from a plastics material.

Preferably, the support frame and the sieve are configured to be releasably engaged with each other, preferably in a form-locking engagement.

Preferably, the support frame and the sieve are configured to be engaged by a movement along an axial direction of the support frame and/or by a lateral movement along a radial direction of the support frame.

Preferably, the support frame and the sieve are provided with mating centering features for defining a mounted position, preferably mating conical surfaces and/or one or more mating protrusions and recesses.

Preferably, the support frame is configured to be moved along a body of the sampling section of the particle monitoring system between a position where it defines the space surrounding the impacting and collecting surface, preferably the petri dish, placed on the sampling section and a position providing access to the sampling section.

Preferably, the sieve is provided with one or more lateral protrusions, preferably in the form of one or more lugs, allowing gripping of the sieve for the purpose of positioning it at the support frame.

Preferably, the sieve is provided with a plurality of radial ribs distributed about the periphery thereof to increase the rigidity against deformation.

Preferably, the support frame is a ring-like body, preferably with one or more lateral protrusions and/or recesses, preferably in the form of a peripheral shoulder or groove.

Preferably, the sieve is configured to be engaged with other sieves to form a self-supporting stack.

Preferably, the sieve and/or the support frame are/is provided with a data tag containing an identifier, preferably of an electronically readable type.

Preferably, the sieve is formed so that, when the sampling lid assembly is mounted on the sampling section, and the sieve is in the mounted position on the support frame, the surfaces of the support frame facing towards the space are shielded from contact with the fluid directed, in operation of the particle monitoring system, through the fluid openings towards the impacting and collecting surface, preferably the petri dish placed on the sampling section.

Preferably, the sampling lid assembly comprises an impacting and collecting surface, preferably a petri dish.

The present application also relates to a particle monitoring system comprising such sampling lid assembly as defined herein.

### BRIEF DESCRIPTION OF THE DRAWINGS

The present invention will in the following be described in detail on the basis of preferred but non-limiting embodiments by reference to the attached exemplary schematic drawings, in which

FIGS. 1a, 1b and 1c show an exemplary and schematic representation of a first embodiment of the sampling lid assembly in a perspective view (FIG. 1a), in a perspective cross-sectional view (FIG. 1b), and in a sectional elevation view (FIG. 1c), each in conjunction with a sampling section of a particle monitoring system;

FIGS. 2a to 2h show an exemplary and schematic representation of a sequence of characteristic stages of an air monitoring process using the sampling lid assembly according to the first embodiment in a perspective view (FIGS. 2a, 2c, 2d, 2f, and 2g) and in a perspective cross-sectional view (FIGS. 2b, 2e, and 2h) each in conjunction with a sampling section of a particle monitoring system;

FIGS. 3a and 3b show an exemplary and schematic representation of a second embodiment of the sampling lid assembly in a perspective view (FIG. 3a) and in a perspective view with the sieve separated from the support frame (FIG. 3b); and

FIGS. 4a to 4c show an exemplary and schematic representation of a third embodiment of the sampling lid assembly in a perspective view of the sieve turned upside-down (FIG. 4a), in a perspective view of the assembled state (FIG. 4b), and in a perspective cross-sectional view (FIG. 4c).

### DETAILED DESCRIPTION

The particle monitoring system and sampling lid assembly of the present invention are now described in connection with various embodiments whereby it is understood that features of the embodiments may be combined with each other.

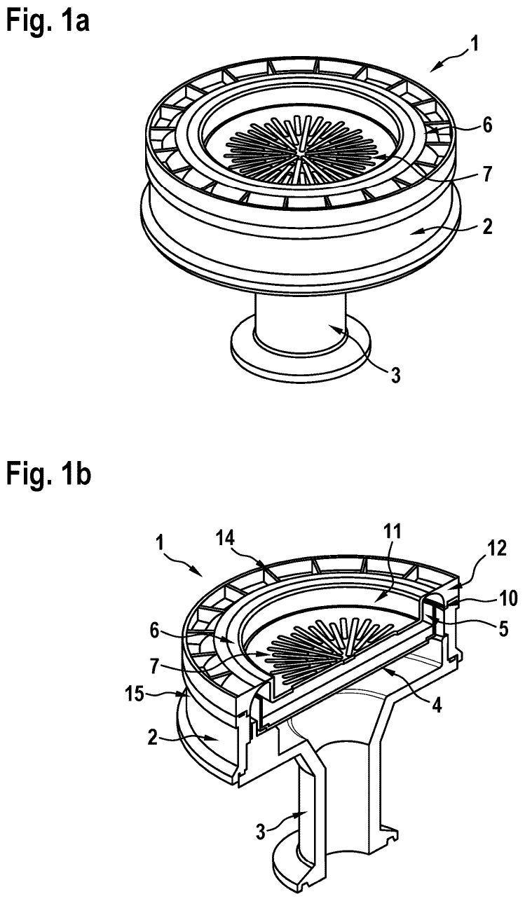

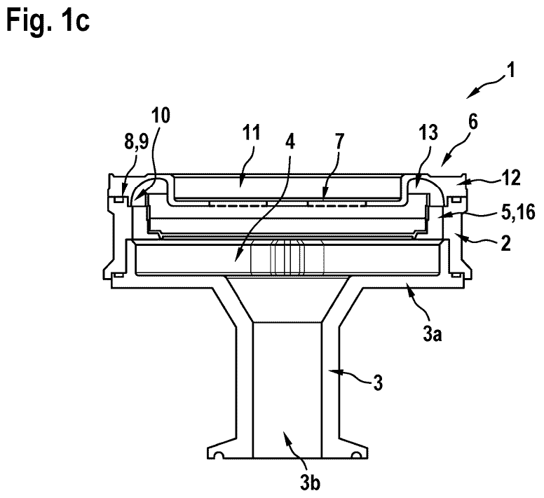

FIGS. 1a to 1c show an exemplary and schematic representation of a first embodiment of the sampling lid assembly 1 according to the invention in conjunction with a sampling section 3 of a particle monitoring system (not shown). It is remarked that the sampling section 3 is not part of the invention but is a component of particle monitoring systems known per se. The sampling lid assembly 1 is in any case designed to be compatible with a respective sampling section 3 to provide the functionality described below.

The sampling lid assembly 1 for a particle monitoring system comprises a support frame 2 configured to be releasably attached and fixed to the sampling section 3 of the particle monitoring system and to define a space 5 surrounding an impacting and collecting surface, such as a petri dish 4, placed on a base 3a of the sampling section 3 (as described above in conjunction with the prior art). Though in the following, the present sampling lid assembly is to be described with a petri dish as impacting and collecting surface, it is to be understood that instead of a petri dish any impacting and collecting surface may be used.

The sampling lid assembly 1 also comprises a sieve 6 formed as a component separate and distinct from the support frame 2 and configured to be removably mounted at the support frame 2 to close (or “cover”) an open side of the space 5 above the petri dish 4. The sieve 6 is provided with an array of fluid openings 7 arranged to direct, in operation of the particle monitoring system, a fluid that may support bacteria contaminants and/or other particles towards a growth or test media accommodated within the petri dish 4 placed on the sampling section 3. The fluid, after having impinged on the media in the petri dish 4, is guided towards the periphery of the sieve 6 and from there through a gap 16 between the support frame and the petri dish to an outlet port 3b of the sampling section (the flow of the fluid is forced by a reduced pressure created by a vacuum pump downstream of the outlet port 3b).

In the prior art the support frame and the sieve are integrally formed. By separating the support frame 2 and the sieve 6 according to the invention, the support frame 2 and the sieve 6 are made from different materials. In particular, the support frame 2 is a reusable component and is made from a material capable of withstanding autoclaving for sterilisation, preferably is made from a metal material, preferably from stainless steel. The sieve 6 is preferably a disposable component made from a disposable material, preferably from a plastics material. The choice of plastics material is not particularly limited. A suitable plastics material may, for example, be selected from the list consisting of acrylonitrile butadiene styrene (ABS); polypropylene (PP), such as propylene homopolymer, propylene random copolymer, or heterophasic propylene block copolymer; polycarbonate (PC); polystyrene (PS), such as high-impact polystyrene (HIPS); polyamides (PA); and polyesters.

The concept of separating the support frame 3 and the sieve 6 is, however, applicable to a concept where the sieve, too, is reusable. In any case, the separation of these two components reduces the volume of the part of the sampling lid assembly 1 (i.e. the sieve) that is disposable while a significant part (i.e. the support frame) is reusable.

The support frame 2 and the sieve 6 are configured to be releasably engaged with each other, preferably but not necessarily in a form-locking engagement.

The support frame 2 and the sieve 6 are configured to be engaged by a movement along an axial direction of the support frame 2 and/or by a lateral movement along a radial direction of the support frame 2. In the embodiment the sieve 6 is provided with an annular ridge 8 protruding downward from a downward-facing side and formed to engage with a mating circular groove 9 recessed in an upper surface of the support frame 2.

The support frame 2 and the sieve 6 may also be provided with mating centering features for defining a mounted position, preferably mating conical surfaces and/or one or more mating protrusions and recesses. As, in use, the sieve is pulled/pushed towards the support frame by the flow of gas (for example, air), a particularly tight connection or engagement is not necessary but may be implemented depending on the situation.

The sieve 6 may also be provided with an extension of an inner wall 10 that extends downward so as to shield substantially the entire inner peripheral wall of the support frame 2 facing towards the space 5. Such an extension (not shown) may be formed of a relatively thin, sheet-like strip of material integrally formed with the sieve and reduces or avoids the exposure of the inner peripheral wall of the support frame to contaminants in the fluid, thereby allowing the support frame to be re-used before having to be cleaned and optionally sterilized again.

The form, number and arrangement of the openings 7 on the upper side of the sieve 6 is not particularly limited as long as it fulfils the function of directing a desired flow of fluid towards the media in the petri dish 4. In the embodiment the openings 7 are in the form of radial, elongated narrow slits directed towards a center of the sieve. The surface where the openings are formed is in the form of a recessed, trough-like portion 11 surrounded by an elevated peripheral rim 12. The lower side of the peripheral rim 12 accommodates and forms an annular channel 13 for directing the fluid through the gap between the support frame 2 and the petri dish 4 to the outlet port 3b.

As shown in FIGS. 1a and 1b, the elevated peripheral rim 12 of the sieve 6 is provided with a number of radial ribs 14 on its upper side, distributed about the circumference, to enhance, in addition to the effect of the elevated peripheral rim 12, the rigidity of the sieve against bending deformation while allowing the material thickness of the walls as such to be reduced. This allows that the sieve can be gripped and handled by a gripper implement of a robot.

The support frame 2 is specifically designed to have a relatively simple geometrical shape with mainly flat and preferably uninterrupted continuous smooth surfaces and only a minimum of recesses or sharp edges. Thus, it can be easily cleaned even without special autoclaving equipment to remove contaminants potentially adhering thereto, whereas the more complex structure of the sieve 6 with slits, openings, ribs etc. does not allow cleaning with such simple equipment and calls for autoclaving or similar if reuse is desired.

In the embodiment the support frame 2 is a ring-like body, preferably with one or more small lateral protrusions and/or recesses, preferably in the form of a peripheral shoulder or shallow groove 15 to avoid that the support frame slides through a gripper of a robot or gloves in case of a manual handling. For ease of implementation, the support frame 2 preferably has a sufficiently wide essentially vertical surface along the outer perimeter, to allow for easy and reliable gripping. The support frame 2 is designed to be fixed to the base 3a of the sampling section 3. This can be realized in that the support frame 2 and the base 3a are provided with mating centering and engaging features for defining a releasable mounted position. As compared to the releasable connection between the sieve and the support frame, the releasable connection between the base 3a and the support frame 2 should be more rigid if the support frame 2 is to remain in place for several cycles of exchange of the sieve 6 as the reusable support ring 2 does not need to be cleaned between each sampling cycle.

By separating the support frame 2 and the sieve 6 according to the invention, the packaging volume of the stock of material is reduced as well in several aspects. First, the disposable single-use sieves 6 can be relatively flat (because the support frame is no longer part of it during storage and handling), and the sieve 6 may be configured to be engaged with other sieves 6 to form a self-supporting stack.

Further, the relatively flat sieve 6 can be provided with a relatively simple rigid primary packaging for the single use sieve in order to permit the automation and robotic use. There will be a synergy of functions between the packaging and the single use sieve for robotic and automated use. The rigid packaging will permit to keep the sieve sterile until the last moment before its use.

Second, the reusable support frame can be provided in smaller numbers depending on the cycle or process time for cleaning. As the cleaning procedures for this component are less demanding, the component can be cleaned in most of the sites of usage on site even without dedicated autoclaving equipment. Thus, the cycle time of cleaning does not have to take account of the time and procedures of handling involved, particularly when the cleaning procedures are externalized, i.e. sent to an external service provider for cleaning.

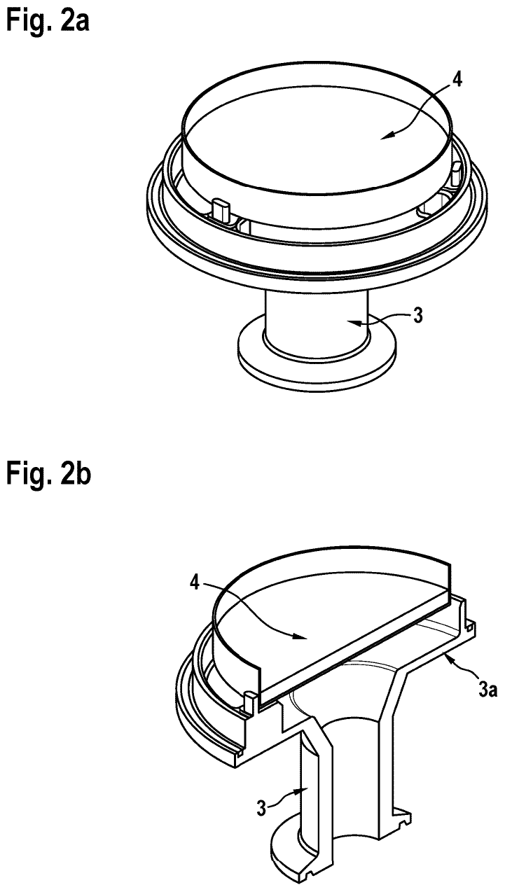

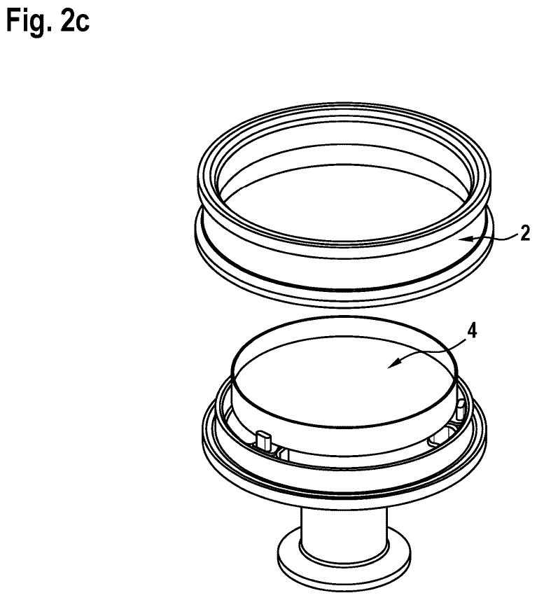

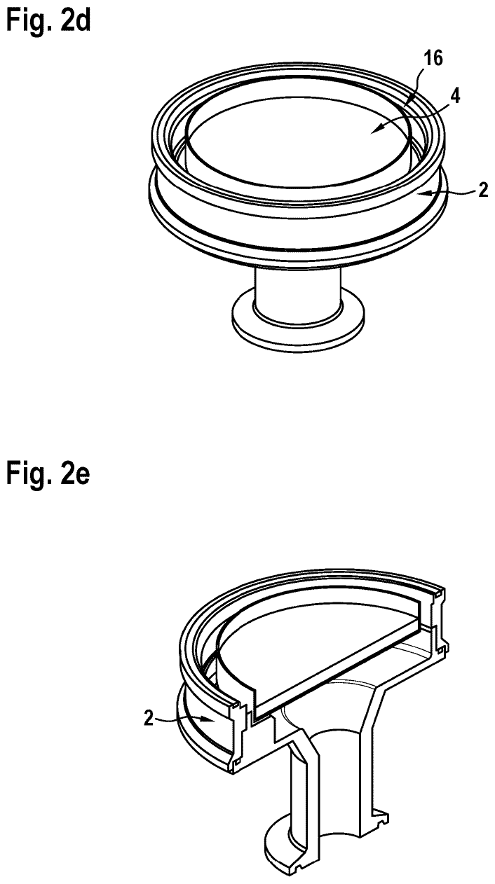

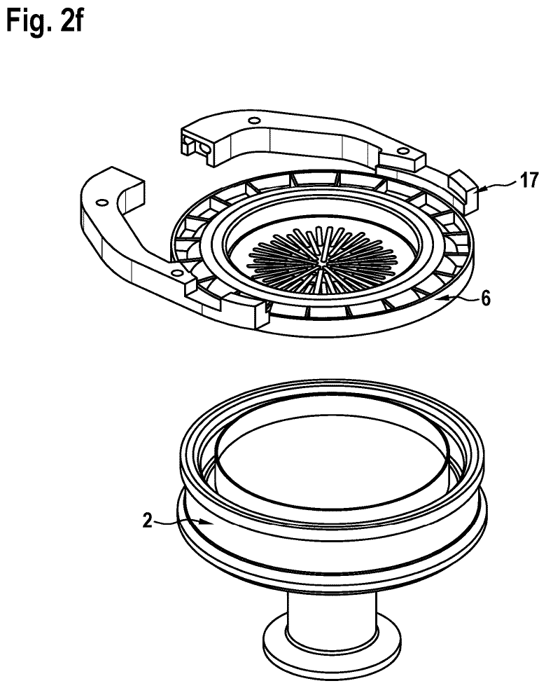

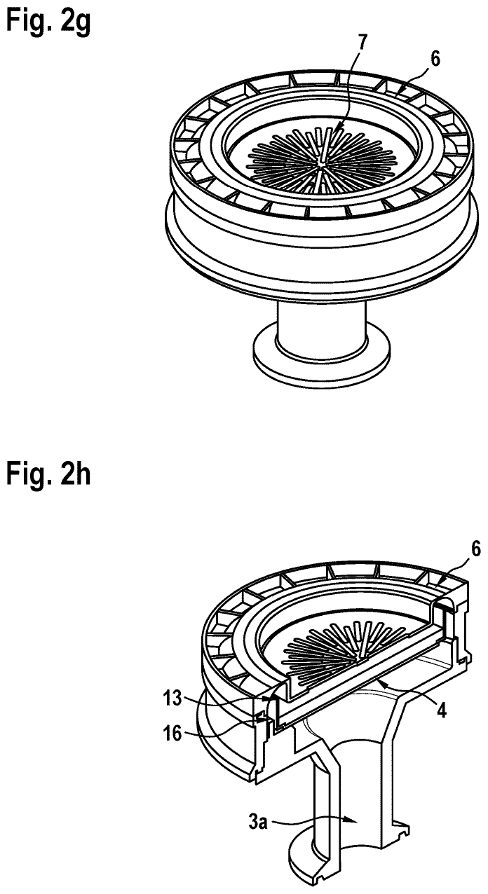

FIGS. 2a to 2h show an exemplary and schematic representation of a sequence of characteristic stages of an air monitoring process using the sampling lid assembly according to the first embodiment in a perspective view (FIGS. 2a, 2c, 2d, 2f, and 2g) and in a perspective cross-sectional view (FIGS. 2b, 2e, and 2h), each in conjunction with the sampling section of a particle monitoring system.

To start an air monitoring process, the petri dish 4 (with the growth or test media, for example agar media) is placed on the base 3a of the sampling section 3 of the particle monitoring system (for example an air sampling system). This stage is shown in FIGS. 2a and 2b and is as such known in the art. The petri dish 4 can be positioned indifferently manually or automatically with a robot.

Then, the reusable support frame 2 is positioned on the base 3a of the sampling section 3, too, so as to surround the petri dish 4 with a gap 16 (see FIGS. 2c to 2e). The support frame 2 can be positioned indifferently manually or automatically with a robot.

In the next step, the disposable sieve 6 is positioned on the reusable support frame 2 (see FIGS. 2f to 2h). The disposable sieve 6 can be positioned indifferently manually or automatically with a robot, wherein FIG. 2f indicates an example where the sieve 6 is gripped by a gripper implement 17 of such a handling robot (not shown). The rigidity of the disposable sieve 6 and, if necessary, the use of a rigid packaging (not shown) as primary packaging of the disposable sieve 6 will permit the automation and robotic use of the proposed solution by using the gripper 17. The primary packaging can be a unit packaging or a packaging of several sieves 6. In the second case, the design of the sieve will preferably allow them to be easily stacked and taken up one-by-one by the gripper implement 17.

Once the sieve 6 is placed on top of the support frame 2, the fluid sampling system is ready to start and a vacuum pump (not shown) is started to suck fluid (air) through the holes 7 of the sieve 6 and the contaminated particles entrained in the stream of fluid are projected onto the surface of the media within the petri dish 4 by the kinetic energy and remain on the media surface. The sucked fluid is forced outward and upward at the peripheral wall of the petri dish 4 and is further guided and turned downward by the annular channel 13 of the sieve 6 and is directed through the gap 16 between the inner peripheral wall of the support frame 3 and the petri dish 4 to the outlet port 3b to finally exit through the port 3b of the air sampling system (see also FIG. 1c).

In a preferred variant the sieve 6 and/or the support frame 2 and optionally the gas (for example, air) sampling system are/is provided with a data tag containing an identifier, preferably of an electronically readable type that is attached on an accessible outer surface of the respective components, that can have a unique data matrix for ensuring an unambiguous traceability of the test performed. Such traceability reading should be compatible for both manual and automated use.

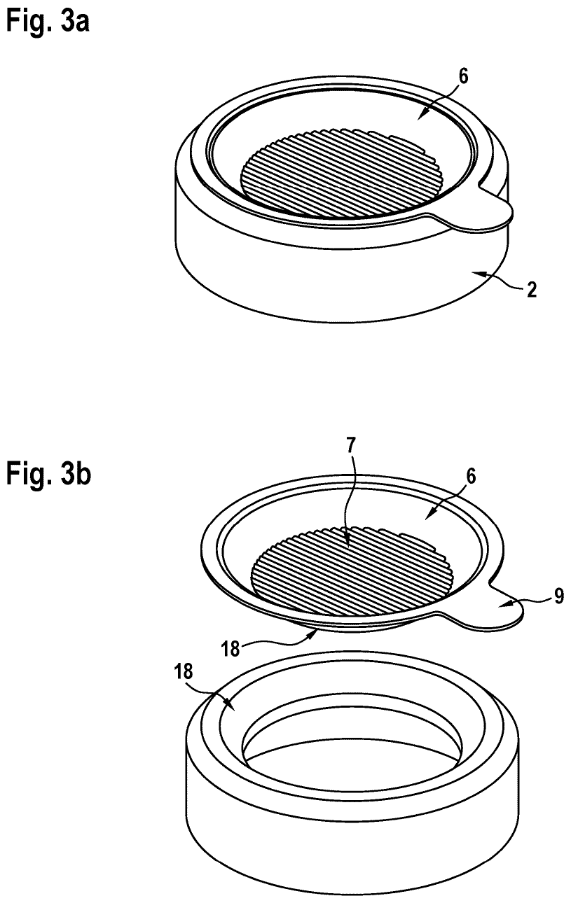

In the second embodiment shown in FIGS. 3a and 3b the support frame 2 and the sieve 6 are provided with mating centering features for defining a mounted position, in this case with mating conical surfaces 18. In the embodiment of FIG. 3b the reusable support frame 2 and the disposable sieve 6 are each designed with a conical shape at the mating contact surfaces in order to facilitate the positioning of the disposable sieve on the support frame 2 even in case of automated handling.

In this second embodiment the sieve 6 is preferably provided with one or more lateral protrusions 9, preferably in the form of one or more lugs (only one being shown), allowing gripping (for example by a gripper on a robotic arm) of the sieve 6 for the purpose of positioning it at the support frame 2 without touching the recessed portion where the openings 7 are provided and without introducing a bending force on the sieve as such.

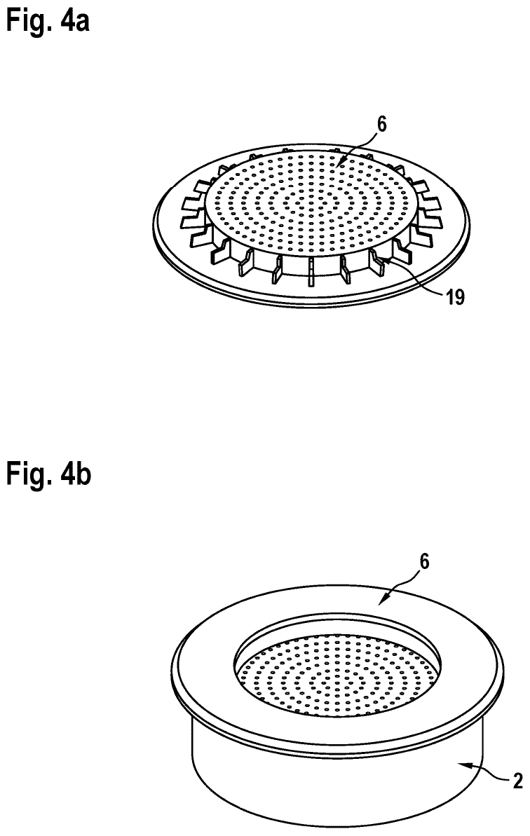

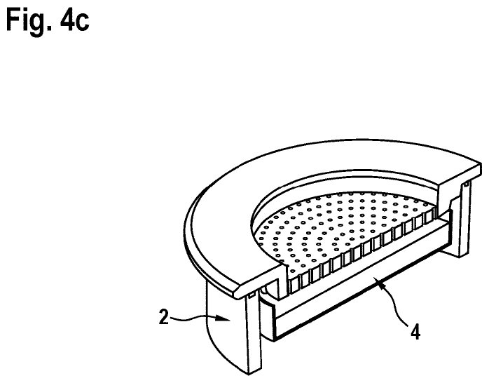

In the third embodiment shown in FIGS. 4a to 4c the support frame 2 and the sieve 6 are provided with mating centering features for defining a mounted position, in this case with one or more mating protrusions 19 in the form of a plurality of ribs arranged on the lower side of the sieve 6 distributed in an annular arrangement around the recessed portion with the openings 7 to engage with the inner peripheral wall of the support frame 2 when turned upside-down. In a further variant (not shown), mating recesses may be provided to cooperate with protrusions to define and fix a specific mounting position.

In the third embodiment the reusable support frame 2 is in the form of a substantially straight cylinder. This form is preferable as it further facilitates the cleaning process without specific equipment. The inner diameter of the support frame or ring can be dimensioned to tightly fit about an outer circumference of the base 3a of the sampling section 3 so that the support frame 2 is configured to be moved along a body of the base 3a of the sampling section 3 between a raised position where it defines the space 5 surrounding a petri dish 4 placed on the sampling section 3 and a lowered position providing access to the sampling section 3. This arrangement allows to retain the support frame 2 on the sampling section 3 while facilitating unimpeded loading of the petri dish 4 when the support frame 2 is moved to the lowered position. In the raised position the sieve can be placed on top of the support frame to cover the petri dish for the sampling operation.

1. A sampling lid assembly (1) for a particle monitoring system comprising:
a support frame (2) configured to be releasably attached to a sampling section (3) of the particle monitoring system and to define a space (5) surrounding an impacting and collecting surface, preferably a petri dish (4), placed on the sampling section (3); and
a sieve (6) configured to be removably mounted at the support frame (2) to close an open side of the space (5) above the impacting and collecting surface, preferably the petri dish (4), the sieve (6) provided with fluid openings (7) arranged to direct, in operation of the particle monitoring system, a fluid towards the impacting and collecting surface, preferably the petri dish (4), placed on the sampling section (3).

2. The sampling lid assembly (1) according to claim 1, wherein the support frame (2) and the sieve (6) are made from different materials.

3. The sampling lid assembly (1) according to claim 1, wherein the support frame (2) is made from a material capable of withstanding autoclaving for sterilization, preferably from a metal material, preferably from stainless steel, and the sieve (6) is made from a disposable material, preferably from a plastics material.

4. The sampling lid assembly (1) according to claim 1, wherein the support frame (2) and the sieve (6) are configured to be releasably engaged with each other, preferably in a form-locking engagement.

5. The sampling lid assembly (1) according to claim 4, wherein the support frame (2) and the sieve (6) are configured to be engaged by a movement along an axial direction of the support frame (2) and/or by a lateral movement along a radial direction of the support frame (2).

6. The sampling lid assembly (1) according to claim 1, wherein the support frame (2) and the sieve (6) are provided with mating centering features for defining a mounted position, preferably mating conical surfaces and/or one or more mating protrusions and recesses.

7. The sampling lid assembly (1) according to claim 1, wherein the support frame (2) is configured to be moved along a body of the sampling section (3) of the particle monitoring system between a position where it defines the space (5) surrounding the impacting and collecting surface, preferably the petri dish (4), placed on the sampling section (3) and a position providing access to the sampling section (3).

8. The sampling lid assembly (1) according to claim 1, wherein the sieve (6) is provided with one or more lateral protrusions (9), preferably in the form of one or more lugs, allowing gripping of the sieve (6) for the purpose of positioning it at the support frame (2).

9. The sampling lid assembly (1) according to claim 1, wherein the sieve (6) is provided with a plurality of radial ribs (14) distributed about the periphery thereof to increase the rigidity against deformation.

10. The sampling lid assembly (1) according to claim 1, wherein the support frame (2) is a ring-like body, preferably with one or more lateral protrusions and/or recesses, preferably in the form of a peripheral shoulder or groove.

11. The sampling lid assembly (1) according to claim 1, wherein the sieve (6) is configured to be engaged with other sieves (6) to form a self-supporting stack.

12. The sampling lid assembly (1) according to claim 1, wherein the sieve (6) and/or the support frame (2) are/is provided with a data tag containing an identifier, preferably of an electronically readable type.

13. The sampling lid assembly (1) according to claim 1, wherein the sieve (6) is formed so that, when the sampling lid assembly (1) is mounted on the sampling section (3), and the sieve (6) is in the mounted position on the support frame (2), the surfaces of the support frame (2) facing towards the space (5) are shielded from contact with the fluid directed, in operation of the particle monitoring system, through the fluid openings (7) towards the impacting and collecting surface, preferably the petri dish (4) placed on the sampling section (3).

14. The sampling lid assembly (1) according to claim 1, wherein the sampling lid assembly (1) comprises an impacting and collecting surface, preferably a petri dish (4).

15. A particle monitoring system comprising the sampling lid assembly according to claim 1.

16. The sampling lid assembly (1) according to claim 1, wherein the support frame (2) is made from stainless steel, and the sieve (6) is made from a disposable plastics material.

17. The sampling lid assembly (1) according to claim 1, wherein the support frame (2) and the sieve (6) are configured to be releasably engaged with each other in a form-locking engagement.

18. The sampling lid assembly (1) according to claim 1, wherein the support frame (2) and the sieve (6) are provided with mating centering features and the mating centering features are mating conical surfaces and/or one or more mating protrusions and recesses.
